(19) United States
(12) Patent Application Publication
(10) Pub. No.: US 2006/0174148 A1
(43) Pub. Date: Aug. 3, 2006

(54) Controller and method for power-down mode in memory card system

(75) Inventor: Sin-Ho Yang, Suwon-si (KR)

Correspondence Address: F. CHAU & ASSOCIATES, LLC, 130 WOODBURY ROAD, WOODBURY, NY, 11797, US

(73) Assignee: SAMSUNG ELECTRONICS CO., LTD., Suwon-si (KR)

(21) Appl. No.: 11/345,797

(22) Filed: Feb. 2, 2006

(30) Foreign Application Priority Data
Feb. 3, 2005 (KR) 2005-10054

(51) Int. Cl. G06F 1/28

(52) U.S. Cl. 713/322

(57) ABSTRACT

Disclosed is a controller and method for regulating a power-down mode in a memory card system. The memory card controller includes a central processor unit, a direct memory accessing (DMA) unit, a buffer, and a power-down detector. The central processor unit accepts commands from a host and the DMA unit stores the number of blocks requested by the host in response to instructions of the central processor unit. The buffer stores data that are read from an external storage device through the DMA unit. The power-down detector outputs a control signal to regulate a system clock by means of detecting a storage condition of the buffer and a read-out condition of the host. As the power-down mode begins, if the host does not read data stored in the buffer even when the buffer is full with data, it is possible to reduce power consumption by the memory card controller.

### CROSS-REFERENCE TO RELATED APPLICATIONS

This U.S. non-provisional patent application claims priority under 35 U.S.C. § 119 of Korean Patent Application 2005-10054 filed on Feb. 3, 2005, the entire contents of which are hereby incorporated by reference.

### BACKGROUND OF THE INVENTION

1. Technical Field

The present invention is concerned with memory card systems, which in particular relates to a controller of a memory card system having a large-capacity storage unit for storing data.

2. Description of the Related Art

Memory cards generally include a storage unit and a controller regulating the storage unit. Exemplary memory cards include Multi-Media Cards (MMC), Secure Digital (SD) cards, Compact Flash cards, and Memory Sticks, each kind being different in operation speed, size, and security level. The memory cards are constructed in small dimensions and are able to store data larger than several-hundreds Mega bytes. Thus, they are widely used in portable electronic devices, such as digital cameras, camcorders, and various game sets.

The controller usually has a power-down mode because reducing power consumption of a portable device is important for supplying data of the storage unit to a host in response to a request from the host. The controller is in an active mode when there is a request from the host. But, if there is no request from the host, the controller turns to a power-down mode to reduce unnecessary power consumption.

FIG. 1 is a block diagram of a conventional memory card system 100.

As illustrated in FIG. 1, the memory card system 100 is composed of a host 120 and a memory card 110 embedded in the host. The memory card 110 has a storage unit 140 and a memory card controller (hereinafter, referred to as “controller”) 130 performing commands of the host 120 using data stored in the storage unit 140.

The controller 130 includes a host interface 131, a buffer 133, a direct memory accessing (DMA) unit 135, a system clock control unit 137, and a central processing unit 139. Responding to a data request from the host 120, the central processing unit 139 stores the number of blocks for the requested data in the DMA unit 135. The DMA unit 135 fetches data from the storage unit 140 in correspondence with the data request and stores the fetched data in the buffer 133, and then decreases the number of blocks for every one-block fetch. After storing all data requested from the host 120 in the buffer 133, the number of the requested data blocks becomes zero, and the DMA unit 135 sends a control signal DONE to the central processing unit 139. Then, the central processing unit 139 generates a control signal HOLD that disables the system clock control unit 137, placing the controller 130 into a power-down mode.

Such a memory card controller may consume more power than necessary because it cannot be put into a power-down mode when in a multi-block read mode. The host 120 does not take data from the buffer 133 even though the buffer 133 is full of data or when a buffer of the host 120 is full of data or the host 120 is performing another task.

A need therefore exists for a memory card controller and method capable of reducing power consumption, which detects a condition when a host does not fetch data from a buffer although the buffer is full of data.

### SUMMARY OF THE INVENTION

An aspect of the invention is a memory card controller being comprised of a central processing unit, a direct memory accessing unit, a buffer, and a power-down detector. The central processing unit receives a request from a host. The direct memory accessing unit stores the number of data blocks requested by the host in compliance with the central processing unit. The buffer stores data read from an external storage unit through the direct memory accessing unit. The power-down detector detects a storage state of the buffer and a read-out state of the host and generates a control signal to regulate a system clock.

A memory card is also provided, comprising a storage unit, and a memory card controller. The memory card controller processes commands of a host by means of data stored in the storage unit, being comprised of a central processing unit, a direct memory accessing unit, a buffer, and a power-down detector. The central processing unit receives a request from a host. The direct memory accessing unit stores the number of data blocks requested by the host in compliance with the central processing unit. The buffer stores data read from an external storage unit through the direct memory accessing unit. The power-down detector detects a storage state of the buffer and a read-out state of the host and generates a control signal to regulate a system clock.

In another aspect of the invention, a method of controlling a power-down mode in a memory card, including the steps of: receiving a request for data from a host; storing the number of data blocks requested by the host; storing data in a buffer from a storage unit; detecting a storage state of the buffer and a read-out state of the host; and generating a control signal to regulate a system clock.

### BRIEF DESCRIPTION OF THE DRAWINGS

The accompanying drawings are included to provide a further understanding of the invention, and are incorporated in and constitute a part of this specification. The drawings illustrate example embodiments of the present invention and, together with the description, serve to explain principles of the present invention. In the drawings:

FIG. 1 is a block diagram of a memory card system by a conventional art;

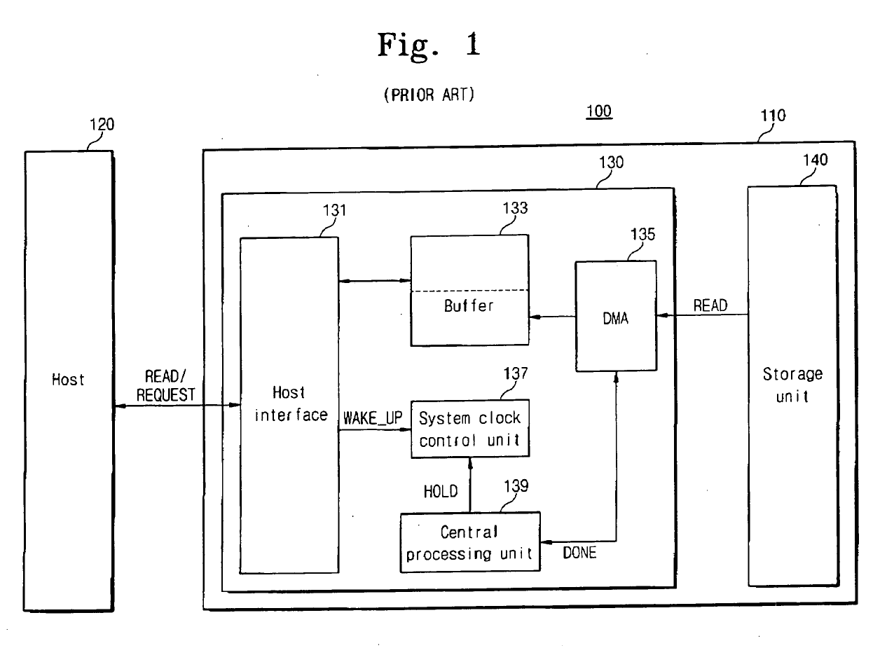

FIG. 2 is a block diagram illustrating a memory card system in accordance with a preferred embodiment of the invention;

FIG. 3 is a block diagram illustrating a power-down detector of the memory card system shown in FIG. 2; and

FIG. 4 is a flow chart showing the procedure of controlling a power-down mode in the memory card system in accordance with a preferred embodiment of the invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the invention to those skilled in the art. Like numerals refer to like elements throughout the specification.

Hereinafter, it will be described about an exemplary embodiment of the present invention in conjunction with the accompanying drawings.

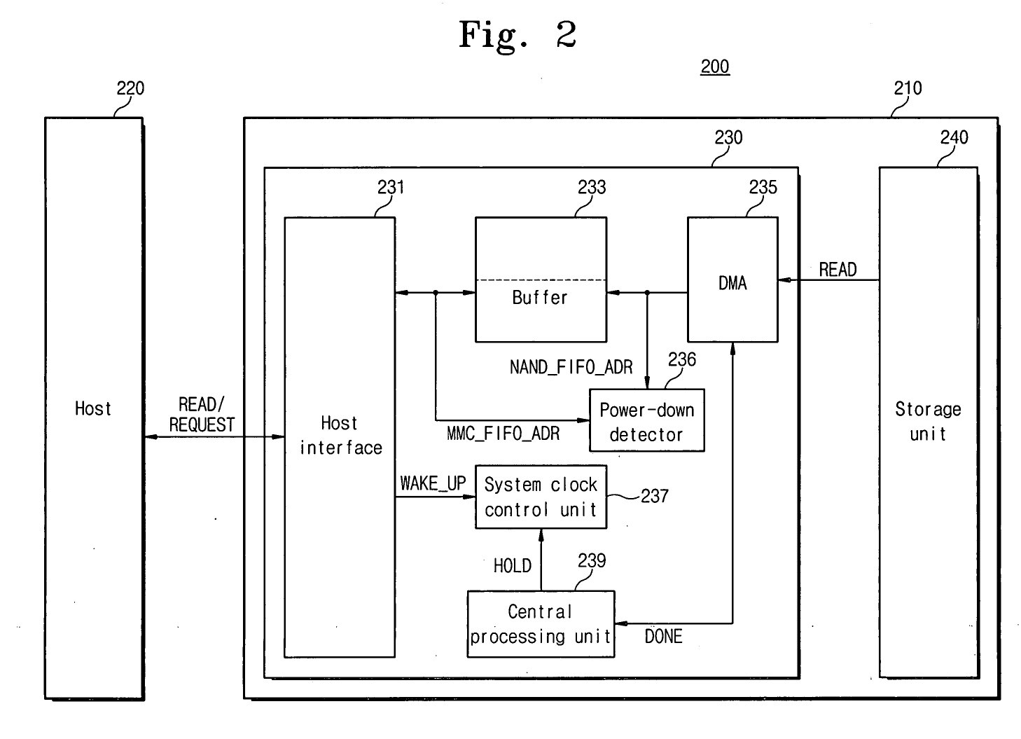

FIG. 2 is a block diagram illustrating a memory card system 200 in accordance with a preferred embodiment of the invention.

Referring to FIG. 2, the memory card system 200 is composed of a host 200 and a memory card 210 embedded in the host 220.

The host 220 may be a digital camera, a digital camcorder, an MP3 player, or a personal digital assistant (PDA), and the memory card 210 may be a Multi-Media Card, Secure Digital™ card, Memory Stick™ card, Compact Flash™ card, or Smart Media™ card.

The memory card 210 is comprised of a storage unit 240, and a memory card controller (hereinafter, referred to as “controller”) 230 to perform commands of the host 220 by means of data stored in the storage unit 240.

The storage unit 240 is used with a nonvolatile memory, e.g., an electrically erasable and programmable read-only-memory (EEPROM) or a NAND flash memory. The controller 230 is comprised of a host interface 231, a buffer 233, a direct memory accessing (DMA) unit 235, a power-down detector 236, a system clock control unit 237, and a central processing unit (CPU) 239. When the host 220 requests data, the CPU 239 stores the number of blocks for the requested data into the DMA unit 235, in which a size of one data block is 512 Bytes. The DMA unit 235 fetches the data requested by the host 220 from the storage unit 240 and stores the fetched data in the buffer 233, in response to the system clock (not shown), decreasing the number of blocks for every one-block fetch. The buffer 233 of the controller 230 is segmented into a plurality of regions for storing the plurality of data blocks, one region being assigned to one block. Further, the buffer 233 is configured with a dual-port SRAM available to store and transmit data at the same time, by which the host can carry out a desired task by reading data from the buffer 233 in response to a host clock (not shown) even when the DMA unit 235 is unable to store data of the storage unit 240 into the buffer 233.

When all data requested by the host 220 are completely stored in the buffer 233, i.e., when the number of the requested data blocks by the DMA unit 235 becomes zero, the DMA unit 235 sends a control signal DONE to the CPU 239. Then, the CPU 239 generates a control signal HOLD that makes the system clock control unit 237 inactivate the system clock, so that the controller 230 is put into a power-down mode.

In the power-down mode, the host 220 executes a predetermined task, reading data stored in the buffer 233 in response to the host clock. If there is a new request for data by the host 220, the system clock control unit 237 enables the system clock to become active from an inactive state in response to a host control signal WAKE_UP. Thus, the DMA unit 235 is able to read the requested data from the storage unit 240 and to store the read-out requested data into the buffer 233.

With an increase of data processing speed in the host 220, read-out speed also becomes important in a memory card. But a single-block read may be insufficient. As a result, a multi-block read that can read data from several blocks in one request by the host may be desirable. However, a conventional memory card controller is not permitted to be put into the power-down mode until all data blocks requested by the host are completely read (or fetched), i.e., until the number of the requested data blocks becomes zero. Therefore, a problem with the multi-block read mode is that the conventional memory card controller consumes power unnecessarily because it cannot be put into the power-down mode when the host does not fetch data from the buffer even though the buffer is full of data, i.e., when a buffer of the host is full of data or the host is performing another task.

For resolving at least the aforementioned problem, the invention is associated with the power-down detector 236 generating a control signal to activate or inactivate the system clock from detecting a storage condition of the buffer 233 and a read-out condition of the host 220. The power-down detector 236 applies the control signal to the system clock control unit 237 to inactivate the system clock without intervention by the CPU 239 when the buffer 233 is full of data and the host 220 does not fetch data from the buffer 233. Accordingly, the controller 230 can turn to the power-down mode to reduce unnecessary power consumption, even before all data blocks requested by the host are not yet read from the storage unit 240, when reading the storage unit 240 is unnecessary (i.e., when the buffer is full of data or the host is prosecuting another work).

In addition, the system clock control unit 237 inactivates the system clock in response to the control signal of the power-down detector 236 as well as the CPU 239. When the power-down detector 236 turns to the power-down mode, a load at the CPU 239 is reduced to improve a data processing speed (or data rate).

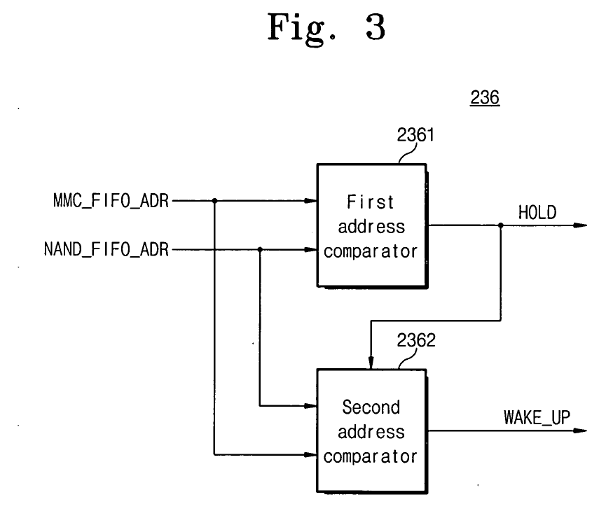

FIG. 3 is a block diagram illustrating the power-down detector 236 of the memory card system 200 shown in FIG. 2.

As shown in FIG. 3, the power-down detector 236 is comprised of a first address comparator 2361 and a second address comparator 2362.

Referring to FIGS. 2 and 3, the DMA unit 235 increases the value of a storage unit address NAND_FIFO_ADR in response to the system clock while storing data into the buffer 233 from the storage unit 240. The host 220 increases the value of a host address MMC_FIFO_ADR in response to the host clock while reading data from the buffer 233. While this embodiment is practiced with a 1 KB-buffer having two 512 B (512 bytes) regions, those skilled in the art will appreciate that the buffer and region sizes may be modified therein. In addition, this embodiment is configured such that the DMA unit 235 stores 1 B data into the buffer 233 for every cycle of the system clock and the host 220 reads 1 B data from the buffer 233 for every cycle of the host clock. However, those skilled in the art will appreciate that the size of the data stored into and read from the buffer may be modified therein.

If the host 220 requests eight data blocks (512 B*8), the CPU 239 sets the number of the requested data blocks on 8 in the DMA unit 235. The DMA unit reads data from the storage unit 240 by 1 byte and stores the read-out into the buffer 233, increasing the storage unit address NAND_FIFO_ADR at the same time. If the data of one block (512 B) are stored in the buffer 233, the number of the requested data blocks is decreased to 7. The host 220 begins to read data from the buffer 233 while increasing the host address MMC_FIFO_ADR at the same time. The operation is repeated until the number of the requested data blocks becomes zero in the DMA unit 235. Then, the control signal DONE is generated, and the CPU 239 applies the control signal HOLD to the system clock control unit 237 to keep the system clock inactive until the host 220 makes a new request.

As aforementioned, in the multi-block read mode, the host 220 frequently does not fetch data from the buffer 233, even when the buffer 233 is full of data, because the host 220 does not perform another task until the task requested by the host 220 (i.e., before the number of the requested data blocks is still not zero) is completed. In this case, power is unnecessarily consumed because the system clock continues to be active.

The power-down detector 236 outputs the control signal to the system clock control unit 237 to inactivate the system clock without intervention by the CPU 239 when the host 220 does not fetch data from the buffer 233 for a predetermined time, i.e., three cycles of the host clock, in the condition that the buffer 233 is full of data, i.e., the two blocks (512 B*2) are full of data. In other words, the first address comparator 2361 of the power-down detector 236 compares the storage unit address NAND_FIFO_ADR with the host address MMC_FIFO_ADR, and then outputs the first control signal HOLD when a difference between the two addresses corresponds to the buffer size (1 KB) and the host address MMC_FIFO_ADR does not vary for a predetermined time (e.g., three host clock cycles).

The system clock control unit 237 inactivates the system clock in response to the first control signal HOLD, by which the memory card system can be put into the power-down mode although the work requested by the host 220 has not been completed. As a result, unnecessary power consumption can be prevented.

As aforementioned, since the buffer 233 is configured in a memory operable with simultaneous storing and transferring data, e.g., a dual-port SRAM, the host 220 can fetch data from the buffer 23 because the host clock maintains its active state even though the system clock is being inactive.

Beginning to fetch (or read) data from the buffer 233 again after completing the work of the host 220, the system clock is activated in response to a control signal WAKE_UP of the host 220 if there is at least one among the plurality regions of the buffer 233. In other words, when a difference between the storage unit address NAND_FIFO_ADR and the host address MMC_FIFO_ADR is larger than the size of one region of the buffer 233, i.e., 512 B, the second control signal WAKE_UP is output from the second address comparator.

After repeating this sequence, if the control signal DONE is generated when the number of the requested data blocks in the DMA unit 235 becomes zero, the CPU 239 sends the first control signal HOLD to the system clock control unit 237 to keep the system clock inactive until the host 220 makes a new request.

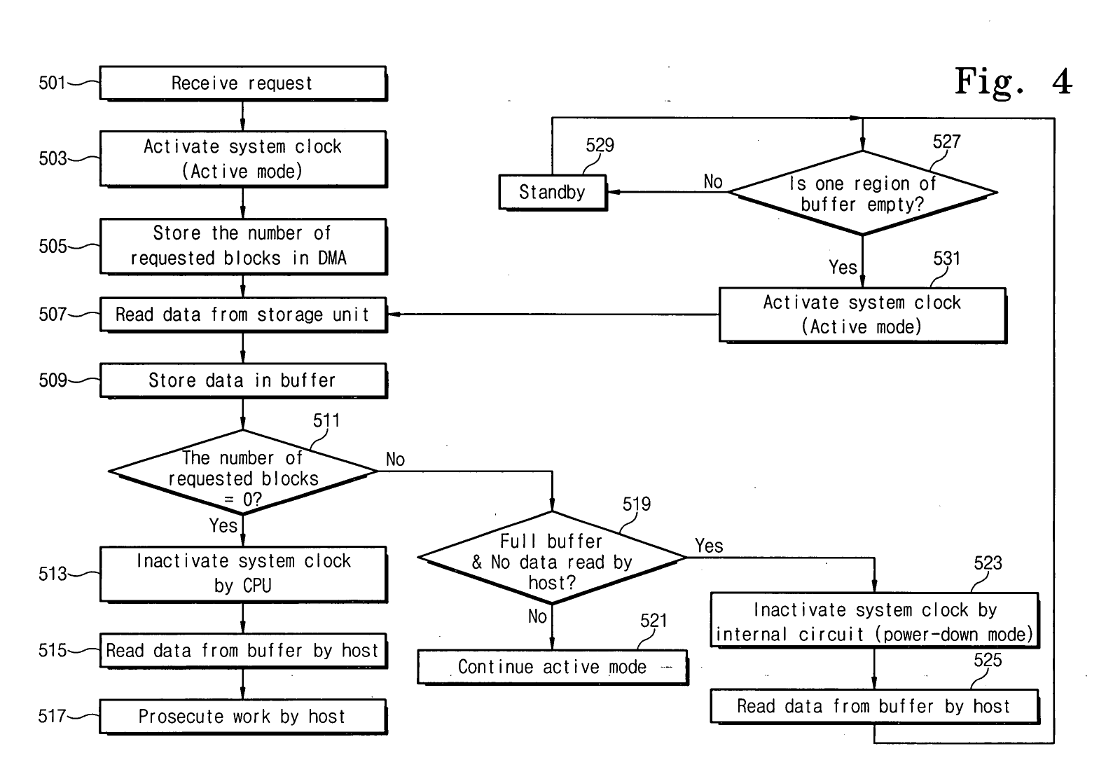

FIG. 4 is a flow chart showing the procedure of controlling a power-down mode in the memory card system in accordance with a preferred embodiment of the invention.

Referring to FIG. 4, the CPU 239 accepts a request for data from the host 220 (step 501), and then an active mode begins in response to activation of the system clock (step 503).

The CPU 239 stores the DMA unit 235 with the number of the data blocks requested by the host 220 (step 505). The DMA unit 235 reads the requested data from the storage unit 240 (step 507) and then stores the read-out requested data into the buffer 233, decreasing the number of the requested data blocks for every one-block fetch (or read) (step 509).

The DMA unit 235 determines whether the stored number of the requested data blocks is zero (step 511). From the determination at the step 511, if the number of the requested data blocks is zero, the CPU 239 generates the control signal to inactivate the system clock to enable the power-down mode (step 513). Then, the host 220 reads data from the buffer 233 (step 515) and performs its task with the fetched data (step 517). The steps 515 and 517 are repeated whenever data are stored in one of the regions of the buffer 233 in the step 509, i.e., whenever data of one block are stored therein.

If the number of the requested data blocks is still detected as not being zero at the step 511, the power-down detector 236 determines that the buffer 233 is full of data or that the host 220 does not read data from the buffer 233 for a predetermined time (i.e., three host clock cycles) (step 519). If the buffer 233 is not full of data or if the host 220 is reading data from the buffer 233, the active mode continues (step 521).

From the determination by the step 519, if the buffer 233 is full of data and if the host 220 does not read data from the buffer 233 for a predetermined time (i.e., three host clock cycles), the control signal is generated to inactivate the system clock without intervention of the CPU 239 so as to enable the power-down mode (step 523).

After completing the work of the host 220, the host 220 reads data from the buffer 233 (step 525). Thereafter, it determines whether one or more regions of the buffer 233 is empty (step 527). If one or more regions of the buffer 233 is not empty, the power-down mode is maintained (step 529). Otherwise, if one or more regions of the buffer 233 is empty, the control signal is enabled to activate the system clock, thereby beginning an active mode (step 531).

From the step 531 forth, the steps next to the step 507 are repeated until the number of the requested data blocks downs to zero.

According to a memory card controller of the invention, power-down mode is enabled when the host does not fetch data from the buffer even though the buffer is full of data, reducing unnecessary power consumption therein.

Moreover, as the power-down controlling operation is carried out without intervention of the central processing unit, the overall operation speed is improved.

Although the invention has been described in connection with the embodiments illustrated in the accompanying drawings, it is not limited thereto. It will be apparent to those skilled in the art that various substitution, modifications and changes may be thereto without departing from the scope and spirit of the invention.

What is claimed is:

1. A memory card controller comprising:
a central processing unit receiving a request from a host, the request including a number of data blocks;
a direct memory accessing unit storing the number of data blocks requested by the host in compliance with the central processing unit;
a buffer storing data read from an external storage unit through the direct memory accessing unit; and
a power-down detector detecting a storage state of the buffer and a read-out state of the host and generating a control signal to regulate a system clock.

2. The memory card controller as set forth in claim 1, which further comprises a system clock control unit activating or inactivating the system clock.

3. The memory card controller as set forth in claim 2, wherein the system clock control unit inactivates the system clock in response to a control signal of the central processing unit or the power-down detector.

4. The memory card controller as set forth in claim 3, wherein the buffer is segmented into pluralities of regions, each region storing data of one block.

5. The memory card controller as set forth in claim 4, wherein the buffer is a memory having dual ports.

6. The memory card controller as set forth in claim 5, wherein the power-down detector applies a control signal to the system clock control unit to inactivate the system clock without intervention of the central processing unit when the buffer is full of data and the host does not fetch data from the buffer.

7. The memory card controller as set forth in claim 5, wherein the direct memory accessing unit increases a storage unit address in accordance with the system clock while storing data in the buffer from the external storage unit,
wherein the host increases a host address in accordance with a host clock while fetching data from the buffer.

8. The memory card controller as set forth in claim 7, wherein the power-down detector applies a control signal to the system clock control unit to inactivate the system clock without intervention of the central processing unit when a difference between the storage unit address and the host address is a size of the buffer and the host address is maintained without change for a given time.

9. The memory card controller as set forth in claim 5, wherein the direct memory accessing unit decreases the number of the data blocks requested by the host whenever storing data into the buffer from the external storage unit.

10. The memory card controller as set forth in claim 9, wherein the central processing unit applies a control signal to the system clock control unit to inactivate the system clock when the number of the data blocks stored in the direct memory accessing unit becomes zero.

11. The memory card controller as set forth in claim 10, wherein the system clock control unit makes the system clock active from an inactive state in response to a control signal of the host when the host makes a new request.

12. The memory card controller as set forth in claim 6, wherein the system clock control unit makes the system clock active from an inactive state in response to a control signal of the host when at least one region of the buffer is empty after the host fetches data from the buffer.

13. The memory card controller as set forth in claim 8, wherein the power-down detector comprises:
a first address comparator outputting a first control signal to inactivate the system clock in response to the storage unit address and the host address; and
a second address comparator outputting a second control signal to activate the system clock in response to the storage unit address, the host address, and the first control signal.

14. A memory card comprising:
a storage unit; and
a memory card controller processing commands of a host by means of data stored in the storage unit,
wherein the memory card controller comprises:
a central processing unit receiving a request from a host, the request including a number of data blocks;
a direct memory accessing unit storing the number of data blocks requested by the host in compliance with the central processing unit;
a buffer storing data read from the storage unit through the direct memory accessing unit; and
a power-down detector detecting a storage state of the buffer and a read-out state of the host and generating a control signal to regulate a system clock.

15. The memory card as set forth in claim 14, wherein the memory card controller further comprises a system clock control unit activating or inactivating the system clock.

16. The memory card as set forth in claim 15, wherein the system clock control unit inactivates the system clock in response to a control signal of the central processing unit or the power-down detector.

17. The memory card as set forth in claim 14, wherein the storage unit is a NAND flash memory.

18. The memory card as set forth in claim 14, wherein the memory card controller is a multi-media card controller.

19. A method of controlling a power-down mode in a memory card, the method comprising:
receiving a request for data from a host, the request including a number of data blocks;
storing the number of data blocks requested by the host;
reading the requested data from a storage unit;
storing the requested data in a buffer;
detecting a storage state of the buffer and a read-out state of the host; and
generating a control signal to regulate a system clock.

20. The method as set forth in claim 19, which further comprises generating a control signal to inactivate the system clock without intervention of a central processing unit when the buffer is full of data and the host does not fetch data from the buffer.

21. The method as set forth in claim 19, which further comprises increasing a storage unit address storing data in the buffer from the storage unit and increasing a host address while fetching data from the buffer into the host.

22. The method as set forth in claim 21, which further comprises generating a control signal to inactivate the system clock without intervention of the central processing unit when a difference between the storage unit address and the host address is a size of the buffer.

23. The method as set forth in claim 19, which further comprises decreasing the number of the data blocks requested by the host whenever storing data into the buffer from the storage unit.

24. The method card controller as set forth in claim 23, which further comprises generating a control signal to inactivate the system clock when the number of the data blocks requested by the host becomes zero.

25. The method as set forth in claim 24, which further comprises making the system clock active from an inactive state in response to a control signal of the host when the host makes a new request.

26. The method as set forth in claim 20, which further comprises making the system clock active from an inactive state in response to a control signal of the host when at least one region of the buffer is empty after the host makes a new request.
